(19) United States
(12) Patent Application Publication
(10) Pub. No.: US 2024/0422278 A1
(43) Pub. Date: Dec. 19, 2024

(54) COMMUNICATION SYSTEM, COMMUNICATION CONTROL SYSTEM, AND NON-TRANSITORY COMPUTER READABLE MEDIUM STORING PROGRAM

(71) Applicant: FUJIFILM Business Innovation Corp., Tokyo (JP)

(72) Inventor: Akira OKAMOTO, Kanagawa (JP)

(73) Assignee: FUJIFILM Business Innovation Corp., Tokyo (JP)

(21) Appl. No.: 18/523,886

(22) Filed: Nov. 30, 2023

(30) Foreign Application Priority Data
Jun. 14, 2023 (JP) 2023-097848

(51) Int. Cl. H04N 1/32; H04L 9/32

(52) U.S. Cl. CPC H04N 1/32128; H04L 9/3213

(57) ABSTRACT

A communication system includes plural image processing apparatuses for which a master machine and a slave machine are set, in which the image processing apparatus set as the slave machine has a function of transmitting an execution request for processing of transmitting data to an external server, and image data of a transmission target to the image processing apparatus set as the master machine, and the image processing apparatus set as the master machine has a function of acquiring an access token for accessing the external server from an authorization server based on an authentication setting performed for the authorization server in advance, and accessing the external server by using the access token, and a function of, in a case where the execution request and the image data are received from the image processing apparatus set as the slave machine, acquiring the access token for accessing the external server from the authorization server based on the authentication setting of the image processing apparatus set as the master machine, accessing the external server by using the access token, and transmitting the image data, in a form attached to an email, to the external server.

### CROSS-REFERENCE TO RELATED APPLICATIONS

This application is based on and claims priority under 35 USC 119 from Japanese Patent Application No. 2023-097848 filed Jun. 14, 2023.

### BACKGROUND

### (i) Technical Field

The present invention relates to a communication system, a communication control system, and a non-transitory computer readable medium storing a program.

### (ii) Related Art

There is a system in which a master machine that can communicate with the outside and a slave machine that can communicate with the master machine are set in a plurality of image processing apparatuses, and the image processing apparatus as the master machine is interposed in a case where the image processing apparatus as the slave machine communicates with the outside.

JP2012-100120A discloses an email acquisition system consisting of a master multifunction machine (master machine) and a slave multifunction machine (slave machine) which are connected to each other, in which the master multifunction machine downloads an email addressed to the master multifunction machine, downloads an email addressed to the slave multifunction machine in response to an alternative acquisition request from the slave multifunction machine, and transmits the alternatively acquired email addressed to the slave multifunction machine to the slave multifunction machine.

### SUMMARY

In a communication system in which an access token is required for the access from a slave machine to the outside and such access is performed via a master machine, in advanced authentication such as OAuth authentication, the access to a connection destination is performed by using an access token acquired through a predetermined authorization flow. For this reason, in a system in which the access from a slave machine to the outside is alternatively performed by a master machine, it is required to prepare a mechanism for the master machine to acquire an access token used for the access based on the slave machine.

Aspects of non-limiting embodiments of the present disclosure relate to a communication system, a communication control system, and a non-transitory computer readable medium storing a program that enable a master machine to acquire an access token used for access based on a slave machine in a communication system in which a plurality of apparatuses for which the master machine and the slave machine are set are included and the access from the slave machine to the outside is alternatively performed by the master machine.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a communication system including a plurality of image processing apparatuses for which a master machine and a slave machine are set, in which the image processing apparatus set as the slave machine has a function of transmitting an execution request for processing of transmitting data to an external server, and image data of a transmission target to the image processing apparatus set as the master machine, and the image processing apparatus set as the master machine has a function of acquiring an access token for accessing the external server from an authorization server based on an authentication setting performed for the authorization server in advance, and accessing the external server by using the access token, and a function of, in a case where the execution request and the image data are received from the image processing apparatus set as the slave machine, acquiring the access token for accessing the external server from the authorization server based on the authentication setting of the image processing apparatus set as the master machine, accessing the external server by using the access token, and transmitting the image data, in a form attached to an email, to the external server.

### BRIEF DESCRIPTION OF THE DRAWINGS

Exemplary embodiment(s) of the present invention will be described in detail based on the following figures, wherein:

FIG. 1 is a diagram showing a configuration example of a communication system to which the present exemplary embodiment is applied;

FIG. 2 is a diagram showing a connection relationship in the communication system according to the present exemplary embodiment;

FIG. 3 is a diagram showing a hardware configuration example of an image processing apparatus;

FIG. 4 is a diagram showing hardware configuration examples of an authorization server and an external server;

FIG. 5 is a diagram showing an example of a functional configuration of the image processing apparatus;

FIG. 6 is a diagram showing an example of a functional configuration of a control unit;

FIG. 7 is a diagram showing a flowchart showing an operation of a master machine in a case where the master machine receives an execution request for processing of a service;

FIG. 8 is a diagram showing a flowchart showing an operation in which, in a case where a slave machine receives the execution request for the processing of the service, the slave machine makes the execution request for the processing of the service via the master machine; and

FIG. 9 is a diagram showing a flowchart showing an operation in which the slave machine makes the execution request for the processing of the service to the external server in a case where a setting execution condition is satisfied.

### DETAILED DESCRIPTION

Hereinafter, an exemplary embodiment of the present invention will be described in detail with reference to the accompanying drawings.

### Configuration of Communication System

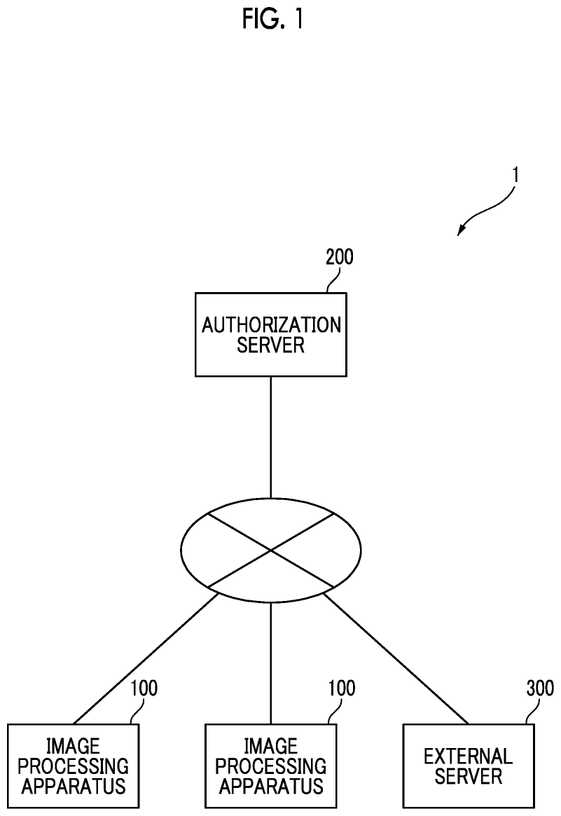

FIG. 1 is a diagram showing a configuration example of a communication system to which the present exemplary embodiment is applied. A communication system 1 includes a plurality of image processing apparatuses 100, an authorization server 200, and an external server 300. The apparatuses 100, 200, and 300 are connected to each other via a network.

The image processing apparatus 100 is an apparatus used by a user. The image processing apparatus 100 refers to an apparatus having a function of reading an image, a function of forming an image, or the like. The image processing apparatus 100 according to the present exemplary embodiment has, for example, a copy function, a print function, a scan function, a facsimile function, and the like. In addition, the image processing apparatus 100 has a communication function, and communicates with the authorization server 200 and the external server 300.

The image processing apparatus 100 receives an execution request for processing of a service from the user, acquires an access token from the authorization server 200 in response to the received execution request for the processing of the service, and accesses the external server 300 by using the acquired access token. In the present exemplary embodiment, an example of processing of the service will be described by using an example in which scanned image data is transmitted, in a form attached to an email, to a destination. The access token can be acquired from the authorization server 200 by the image processing apparatus 100 making an issuance request for the access token to the authorization server 200. In order to acquire the access token, the image processing apparatus 100 is required to perform an authentication setting for the authorization server 200 in advance. In addition, examples of the external server 300 include an SMTP server having a function of transmitting an email.

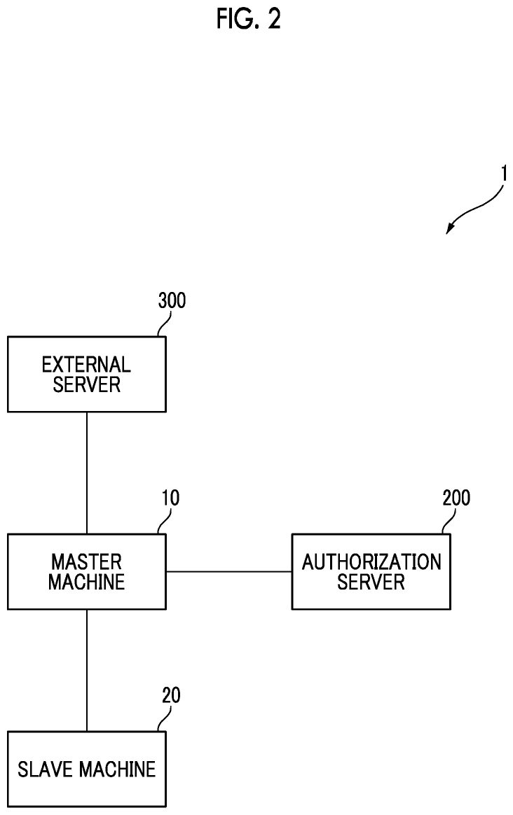

FIG. 2 is a diagram showing a connection relationship in the communication system according to the present exemplary embodiment.

In the communication system 1 to which the present exemplary embodiment is applied, the image processing apparatus 100 (see FIG. 1) is distinguished into a master machine 10 and a slave machine 20. The master machine 10 refers to the image processing apparatus 100 that communicates with the authorization server 200 and the external server 300. The slave machine 20 refers to the image processing apparatus 100 that does not communicate with the authorization server 200 and the external server 300. The slave machine 20 communicates with the master machine 10, and makes the execution request for the processing of the service to the external server 300 via the master machine 10. Each image processing apparatus 100 operates as both the master machine 10 and the slave machine 20 depending on the setting. Hereinafter, the image processing apparatus 100 that operates as the master machine 10 will be referred to as the “master machine 10”, and the image processing apparatus 100 that operates as the slave machine 20 will be referred to as the “slave machine 20”. However, in a case where the master machine 10 and the slave machine 20 are not required to be distinguished from each other, the master machine 10 and the slave machine 20 may be referred to as the “image processing apparatus 100”.

The image processing apparatus 100 has a function of operating as both the master machine 10 and the slave machine 20, but in the communication system 1, the image processing apparatus 100 operates as any one of the master machine 10 or the slave machine 20 depending on the setting. In each image processing apparatus 100, the settings of the master machine 10 and the slave machine 20 can be switched. Hereinafter, the master machine 10 and the slave machine 20 will be further described.

As described above, the master machine 10 is the image processing apparatus 100 that communicates with the authorization server 200 and the external server 300. The image processing apparatus 100 set as the master machine 10 acquires the access token for accessing the external server 300 from the authorization server 200 based on the authentication setting performed for the authorization server 200 in advance, and accesses the external server 300 by using the acquired access token.

In addition, in a case where an execution request for processing of transmitting data to the external server 300, or image data of a transmission target (hereinafter, the image data of the transmission target will be referred to as “image data”) are received from the image processing apparatus 100 set as the slave machine 20, the master machine 10 acquires the access token for accessing the external server 300 from the authorization server 200 based on the authentication setting of the image processing apparatus 100 set as the master machine 10, accesses the external server 300 by using the acquired access token, and transmits the image data, in a form attached to the email, to the external server 300.

As described above, the slave machine 20 is the image processing apparatus 100 that does not communicate with the authorization server 200 and the external server 300. The slave machine 20 communicates with the master machine 10. The image processing apparatus 100 set as the slave machine 20 transmits the execution request for the processing of transmitting the data to the external server 300, or the image data to the image processing apparatus 100 set as the master machine 10.

The authorization server 200 is a server that issues the access token. The authorization server 200 performs the authentication setting of the master machine 10 in response to the execution request for the authentication setting by the master machine 10. The authorization server 200 receives the issuance request for the access token from the master machine 10. The authorization server 200 issues the access token in accordance with the authentication setting performed in advance, and transmits the access token to the master machine 10.

The external server 300 is a server that provides the service. The external server 300 receives the execution request for the processing of the service from the master machine 10. The external server 300 checks whether or not the access token used by the master machine 10 is valid. After checking that the access token is valid, the external server 300 permits the master machine 10 to access the external server 300. On the other hand, after checking that the access token is not valid, the external server 300 does not perform the subsequent operation.

### Hardware Configuration of Image Processing Apparatus

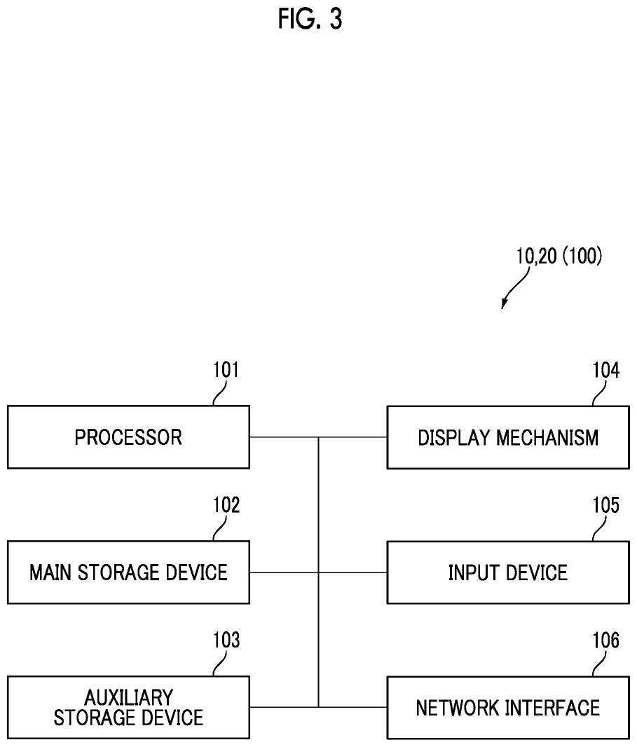

FIG. 3 is a diagram showing a hardware configuration example of the image processing apparatus 100. The image processing apparatus 100 shown in FIG. 3 includes one or a plurality of processors 101 which are arithmetic units, a main storage device (main memory) 102 and an auxiliary storage device 103 which are storage units, a display mechanism 104 for visually recognizing display information, an input device 105 for receiving an operation from the user, and a network interface 106 used for information communication. The processor 101 implements each function of the image processing apparatus 100 by reading a program stored in the auxiliary storage device 103 into the main storage device 102 and executing the program. As the processor 101, for example, a central processing unit (CPU), a micro processing unit (MPU), a graphics processing unit (GPU), or a digital signal processor (DSP) is used. As the main storage device 102, for example, a random access memory (RAM) is used. As the auxiliary storage device 103, for example, a magnetic disk device or a solid state drive (SSD) is used. As the display mechanism 104, for example, a display is used. As the input device 105, for example, a keyboard, a mouse, or a touch panel is used. The configuration of the image processing apparatus 100 shown in FIG. 3 is merely an example, and the image processing apparatus 100 used in the present exemplary embodiment is not limited to the configuration example of FIG. 3. For example, the storage device may include a non-volatile memory such as a flash memory, or a read only memory (ROM).

### Hardware Configuration of Authorization Server and External Server

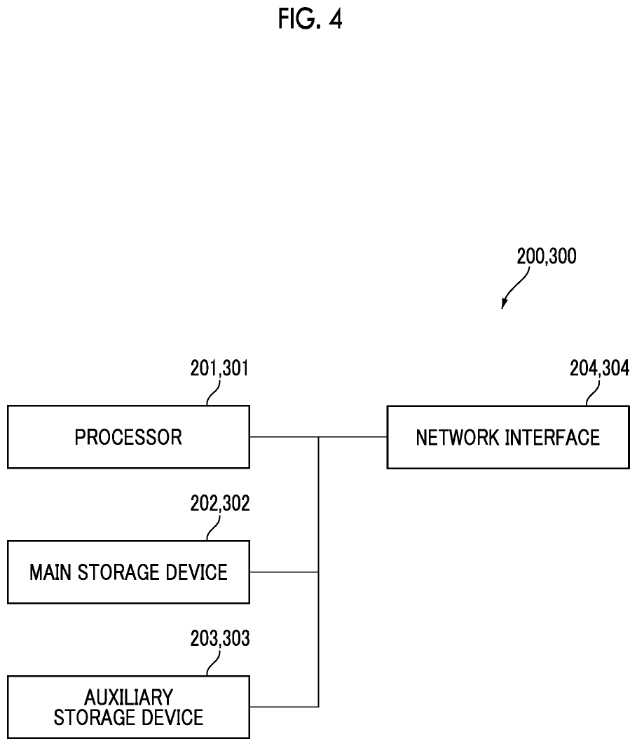

FIG. 4 is a diagram showing hardware configuration examples of the authorization server 200 and the external server 300. The authorization server 200 and the external server 300 shown in FIG. 4 include one or a plurality of processors 201 and 301 which are arithmetic units, main storage devices (main memories) 202 and 302 and auxiliary storage devices 203 and 303 which are storage units, and network interfaces 204 and 304 used for information communication. The processors 201 and 301 implement the functions of the authorization server 200 and the external server 300 by reading programs stored in the auxiliary storage devices 203 and 303 into the main storage devices 202 and 302 and executing the programs. As the processors 201 and 301, for example, a CPU, an MPU, a GPU, or a DSP is used. As the main storage devices 202 and 302, for example, a RAM is used. As the auxiliary storage devices 203 and 303, for example, a magnetic disk device or an SSD is used. The configuration of the servers shown in FIG. 4 are merely examples, and the servers used in the present exemplary embodiment are not limited to the configuration examples of FIG. 4. For example, the storage device may include a non-volatile memory such as a flash memory, or a ROM.

### Functional Configuration of Image Processing Apparatus

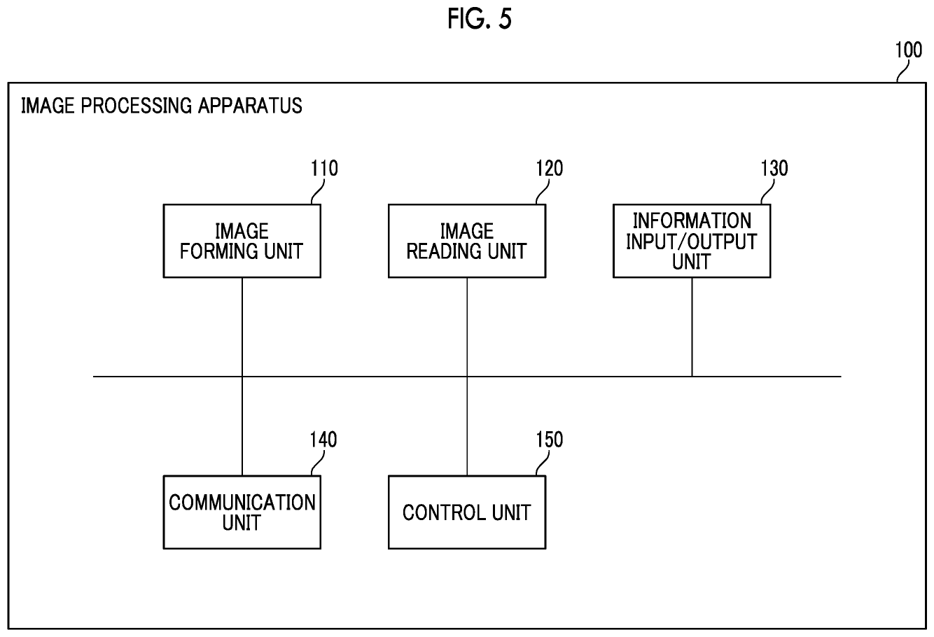

FIG. 5 is a diagram showing an example of a functional configuration of the image processing apparatus 100. The image processing apparatus 100 includes an image forming unit 110, an image reading unit 120, an information input/output unit 130, a communication unit 140, and a control unit 150. Each function of the image processing apparatus 100 is implemented by the processor 101 reading the program stored in the auxiliary storage device 103 into the main storage device 102 and executing the program. The image processing apparatus 100 displays various screens via the display mechanism 104, and receives the input from the user via the input device 105.

The image forming unit 110 forms an image based on the image data on paper which is an example of a recording material by using an image forming material. As a method of forming the image on the recording material, for example, an electrophotographic method of forming the image by transferring toner attached to a photoreceptor onto the recording material, or an ink jet method of forming the image by ejecting ink onto the recording material is used.

The image reading unit 120 is configured by a so-called scanner device, optically reads an image on a set document, and generates data of the read image. As a method of reading the image, for example, a charge coupled device (CCD) method in which a reflected light of light applied to an original from a light source is reduced by a lens and is received by a CCD, or a contact image sensor (CIS) method in which reflected light of light sequentially applied to an original from a light emitting diode (LED) light source is received by a CIS may be used.

The information input/output unit 130 is a user interface that displays a preview image of an image that is a target of processing such as reading or output, an operation image for the user to perform the operation, or the like, and receives the selection of the service to be used from the user.

The communication unit 140 performs the communication or the transmission and reception of the data with an external apparatus. Specifically, the communication between the image processing apparatuses 100 and the communication between the image processing apparatus 100, and the authorization server 200 and the external server 300 are performed via the communication unit 140. In addition, the transmission or the like of the image data scanned by the image processing apparatus 100 is performed via the communication unit 140.

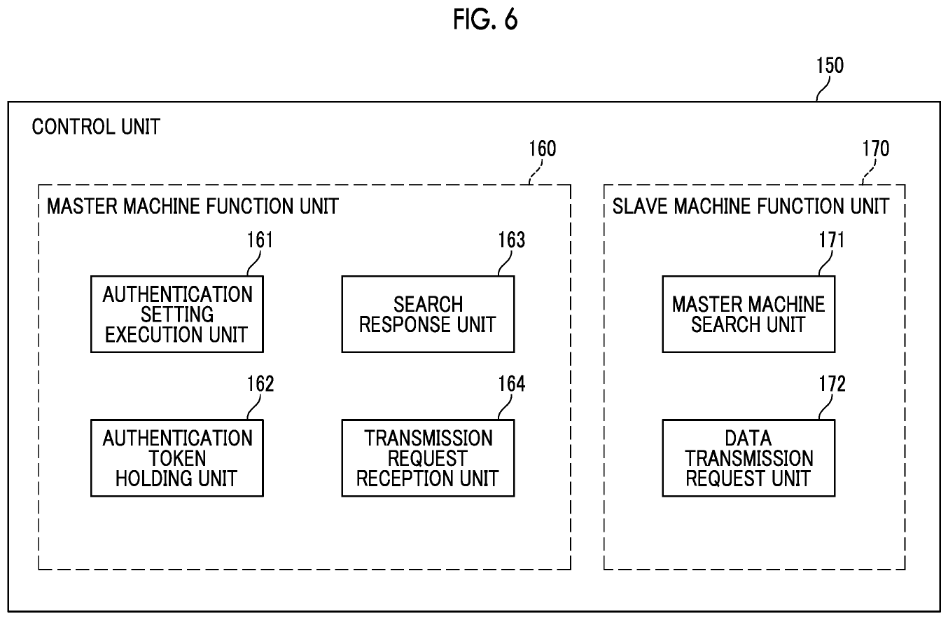

FIG. 6 is a diagram showing an example of a functional configuration of the control unit 150. The control unit 150 controls an operation of each of the functional units of the image processing apparatus 100. Specifically, an operation of transmitting an instruction to each of the functional units or an operation of receiving a response from each of the functional units is performed via the control unit 150. For example, in a case where a scan instruction for the image is received from the user via the information input/output unit 130, the control unit 150 transmits a reading instruction for the image to the image reading unit 120. In addition, in the present exemplary embodiment, the control unit 150 performs different controls in a part of functions between a case where the image processing apparatus 100 operates as the master machine 10 and a case where the image processing apparatus 100 operates as the slave machine 20. The control unit 150 includes a master machine function unit 160 that functions in a case where the image processing apparatus 100 operates as the master machine 10, and a slave machine function unit 170 that functions in a case where the image processing apparatus 100 operates as the slave machine 20, and causes the image processing apparatus 100 to operate as the master machine 10 or the slave machine 20. Further, in a case where the image processing apparatus 100 operates as the master machine 10, the control unit 150 performs control of communicating with the slave machine 20, the authorization server 200, and the external server 300. On the other hand, in a case where the image processing apparatus 100 operates as the slave machine 20, the control unit 150 performs control of communicating with the master machine 10.

The master machine function unit 160 functions in a case where the image processing apparatus 100 operates as the master machine 10. The master machine function unit 160 includes an authentication setting execution unit 161, an authentication token holding unit 162, a search response unit 163, and a transmission request reception unit 164.

The authentication setting execution unit 161 performs the authentication setting between the master machine 10 and the authorization server 200. As information for performing the authentication setting, for example, a user ID or a password is used. In addition, as information for connecting to the authorization server 200, a URL or the like of the authorization server 200 is also included in the information for performing the authentication setting. In addition, the authentication setting execution unit 161 makes the issuance request for the access token to the authorization server 200 in response to the execution request for the processing of the service by the user. The authentication token holding unit 162 acquires the access token issued by the authorization server 200 in accordance with the authentication setting, and holds the access token in the image processing apparatus 100 as the master machine 10.

The search response unit 163 responds to the slave machine 20 that the image processing apparatus 100 as the master machine 10 is the master machine 10 in response to the search for the master machine 10 being performed by a master machine search unit 171 included in the slave machine function unit 170. Examples of the response include notifying the slave machine 20 that the authentication setting is completed for the master machine 10 in the authorization server 200. In addition, the transmission request reception unit 164 receives a transmission request for the image data from a data transmission request unit 172 included in the slave machine function unit 170.

The slave machine function unit 170 includes the master machine search unit 171 and the data transmission request unit 172. The master machine search unit 171 searches for whether or not there is the master machine 10 for which the authentication setting is completed, with the peripheral authorization server 200. The term “peripheral” refers to, for example, on the identical network or on a sub-network. In addition, an IP address of the master machine 10 may be manually set in the slave machine 20 in advance. In addition, the data transmission request unit 172 requests the master machine 10 specified by the master machine search unit 171 to transmit the image data to the external server 300.

### Description of Operation Outline of Communication System

An operation outline of the communication system 1 will be described. The present exemplary embodiment will be described with reference to an example of the processing of the service by giving an example of transmitting the image data, in a form attached to the email, to the destination. In addition, the SMTP server is used as an example of the external server 300 that provides an email transmission service.

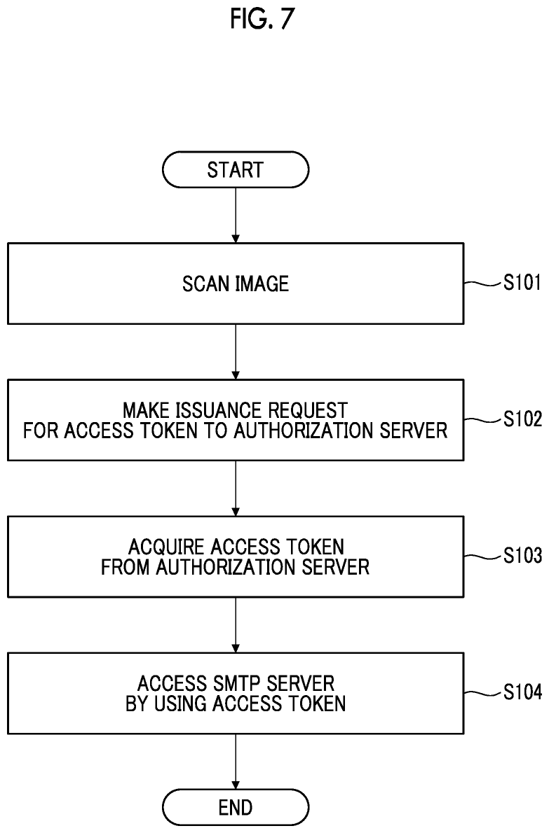

FIG. 7 is a diagram showing a flowchart showing an operation of the master machine 10 in a case where the master machine 10 receives the execution request for the processing of the service. It is assumed that the authentication setting execution unit 161 performs the authentication setting with the authorization server 200 in advance. As a result, in a case where the execution request for the processing of the service is received from the user, the access token can be acquired from the authorization server 200. In a case where the scan instruction is received from the user, the image reading unit 120 scans the image (S101). Further, in a case where an instruction to transmit the scanned image data, in a form attached to the email, to the destination is received from the user, the authentication setting execution unit 161 makes the issuance request for the access token to the authorization server 200 (S102). In a case where the access token is issued by the authorization server 200, the authentication token holding unit 162 acquires the access token from the authorization server 200 (S103). The communication unit 140 accesses the SMTP server by using the acquired access token (S104). By this series of operations, the image data scanned by the master machine 10 is transmitted, in a form attached to the email, to the SMTP server.

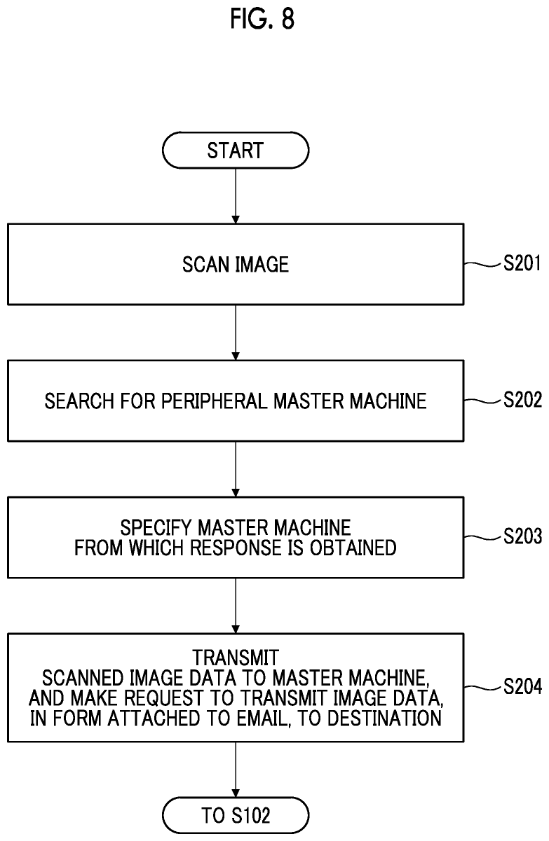

FIG. 8 is a diagram showing a flowchart showing an operation in which, in a case where the slave machine 20 receives the execution request for the processing of the service, the slave machine 20 makes the execution request for the processing of the service via the master machine 10. It is assumed that the authentication setting execution unit 161 in the master machine 10 performs the authentication setting with the authorization server 200 in advance. In a case where the slave machine 20 receives the scan instruction from the user, the image reading unit 120 scans the image (S201). Further, in a case where the slave machine 20 receives an instruction to transmit the scanned image data, in a form attached to the email, to the destination from the user, the master machine search unit 171 searches for the peripheral master machine 10 (S202). In a case where the response is obtained from the master machine 10, the master machine search unit 171 specifies the master machine 10 from which the response is obtained (S203). A case where the response is not obtained from the master machine 10 will be described below. The slave machine 20 transmits the scanned image data to the specified master machine 10 via the communication unit 140, and makes a request to transmit the image data, in a form attached to the email, to the destination (S204).

The master machine 10 receives the transmission request for the image data together with the image data from the slave machine 20. As subsequent operations, the identical operations to S102 to S104 in FIG. 7 are performed. By this series of operations, the image data scanned by the slave machine 20 is transmitted, in a form attached to the email, to the SMTP server via the master machine 10.

In the above-described example, in a case where the response is obtained from the master machine 10, the slave machine 20 makes the execution request for the processing of the service to the external server 300 via the master machine 10. However, in a case where the response is not obtained from the master machine 10, the slave machine 20 cannot make the execution request for the processing of the service to the external server 300 via the master machine 10. As the reason why the response cannot be obtained from the master machine 10, for example, a case where the image processing apparatus 100 set as the master machine 10 is not operating due to power being turned off or the like, or a case where the image processing apparatus 100 does not function as the master machine 10 due to a failure or the like may be considered. Therefore, an aspect in which the slave machine 20 is an alternative to the master machine 10 may also be considered.

### Modification Example

In the present modification example, a condition (hereinafter, referred to as a “setting execution condition”) for the slave machine 20 to perform the authentication setting for the authorization server 200 is defined in advance. In a case where the setting execution condition is satisfied, the slave machine 20 is the new master machine 10, performs the authentication setting for the authorization server 200, acquires the access token for accessing the external server 300 from the authorization server 200, and accesses the external server 300 by using the acquired access token. Examples of the setting execution condition include that the slave machine 20 determines that the image processing apparatus 100 set as the master machine 10 does not function as the master machine 10.

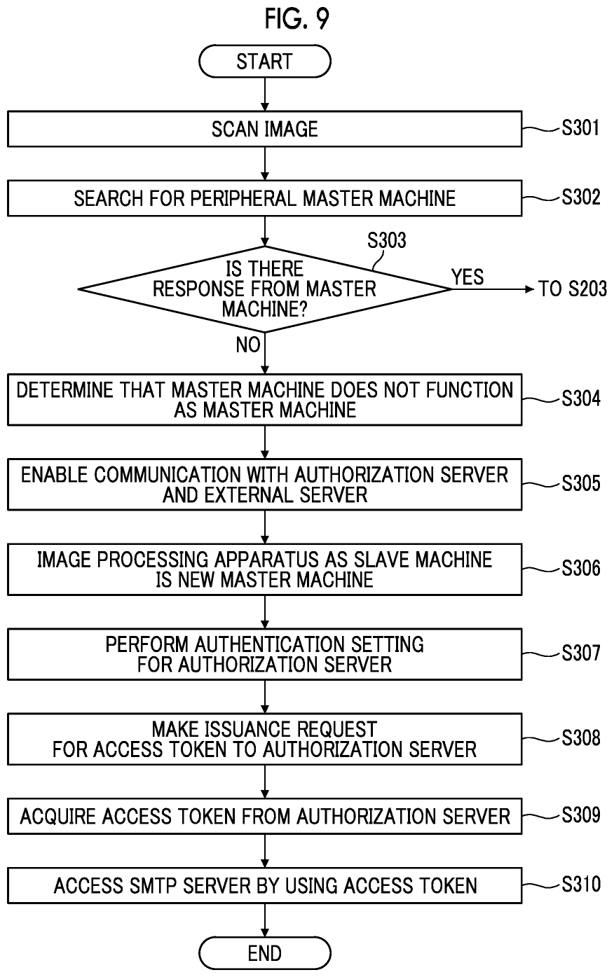

FIG. 9 is a diagram showing a flowchart showing an operation in which the slave machine 20 makes the execution request for the processing of the service to the external server 300 in a case where the setting execution condition is satisfied. It is assumed that the authentication setting execution unit 161 in the master machine 10 performs the authentication setting with the authorization server 200 in advance. In addition, the slave machine 20 acquires the information for performing the authentication setting for the authorization server 200 from the master machine 10, and holds the acquired information. In a case where the master machine 10 is operating, the slave machine 20 acquires the information for performing the authentication setting for the authorization server 200 from the master machine 10 based on a predetermined acquisition condition. Examples of the predetermined acquisition condition include that the power of the slave machine 20 is turned on. In addition, an acquisition timing such as once a week or once a month may be set, and the acquisition timing may be set as the acquisition condition. Further, in a case where the power of the master machine 10 is scheduled to be turned off, a setting may be performed to notify the slave machine 20 from the master machine 10 at a specific time before the power is turned off, and a fact that the slave machine 20 receives the notification form the master machine 10 may be used as the acquisition condition.

In a case where the slave machine 20 receives the scan instruction from the user, the image reading unit 120 scans the image (S301). Further, in a case where the slave machine 20 receives an instruction to transmit the scanned image data, in a form attached to the email, to the destination from the user, the master machine search unit 171 searches for the peripheral master machine 10 (S302). The master machine search unit 171 checks whether or not the response is obtained from the master machine 10 (S303). In a case where the response is obtained from the master machine 10, the processing proceeds to S203 in FIG. 8, and the identical operations to S203 to S204 are performed as subsequent operations.

In a case where the response is not obtained from the master machine 10, the control unit 150 in the slave machine 20 determines that the image processing apparatus 100 set as the master machine 10 does not function as the master machine 10 (S304). Next, it is assumed that the setting execution condition is satisfied, the control unit 150 enables the communication with the authorization server 200 and the external server 300 via the communication unit 140 (S305). The control unit 150 in the slave machine 20 operates the image processing apparatus 100 as the slave machine 20 as the new master machine 10 (S306). Hereinafter, the image processing apparatus 100 that does not function as the master machine 10 will be referred to as a “master machine 10A”, and the image processing apparatus 100 that functions as the new master machine 10 will be referred to as a “master machine 10B”. The authentication setting execution unit 161 in the master machine 10B performs the authentication setting for the authorization server 200 by using the information, which is acquired in advance, for performing the authentication setting for the authorization server 200 (S307). The authentication setting execution unit 161 in the master machine 10B makes the issuance request for the access token to the authorization server 200 (S308). In a case where the access token is issued by the authorization server 200, the authentication token holding unit 162 in the master machine 10B acquires the access token from the authorization server 200 (S309). The communication unit 140 in the master machine 10B accesses the SMTP server by using the acquired access token (S310). By this series of operations, even in a case where the transmission of the image data cannot be executed via the master machine 10, the image data scanned by the slave machine 20 is transmitted, in a form attached to the email, to the SMTP server.

In the above-described example, as an example of the setting execution condition, a case where the slave machine 20 determines that the image processing apparatus 100 set as the master machine 10 does not function as the master machine 10 has been described. However, the setting execution condition is not limited to the above-described example. For example, a case where the slave machine 20 cannot be connected to the image processing apparatus 100 set as the master machine 10 for some reason, for example, a communication trouble or the like may be set as the setting execution condition. In a case where the slave machine 20 satisfies any one of the predetermined setting execution conditions, the slave machine 20 performs the authentication setting for the authorization server 200.

In addition, an aspect can be adopted in which the master machine 10B that can acquire the access token from the authorization server 200 by performing authentication setting for the authorization server 200 notifies another slave machine 20 that the image processing apparatus 100 as the master machine 10B is the master machine 10B. The master machine 10B receives the execution request for the processing of the service, or the image data from the image processing apparatus 100 set as the other slave machine 20. As subsequent operations, the identical operations to S102 to S104 in FIG. 7 are performed. By this series of operations, the image data scanned by the other slave machine 20 is transmitted, in a form attached to the email, to the SMTP server via the master machine 10B.

Next, a connection relationship of the communication system 1 in a case where the master machine 10 that does not function is restored will be described. In a case where the master machine 10 that does not function is restored for some reason, there are a plurality of image processing apparatuses 100 that can operate as the master machine 10. In such a case, only one of the plurality of image processing apparatuses 100 that can operate as the master machine 10 may be set to operate as the master machine 10, and the other image processing apparatus 100 may be set to operate as the slave machine 20. In a case where the above-described example is used, the image processing apparatus 100 that can operate as the master machine 10 is the master machine 10A and the master machine 10B because the master machine 10A that does not function is restored. In such a case, for example, by setting the master machine 10A to operate as the master machine 10 and the master machine 10B to operate as the slave machine 20, only one of the plurality of image processing apparatuses 100 that can operate operates as the master machine 10.

On the other hand, in a case where there are the plurality of image processing apparatuses 100 that can operate as the master machine 10 due to the restoration of the master machine 10 that does not function, the plurality of image processing apparatuses 100 may be set to coexist as the master machine 10. In a case where the above-described example is used, the image processing apparatus 100 that can operate as the master machine 10 is the master machine 10A and the master machine 10B because the master machine 10A that does not function is restored. In such a case, for example, by setting the master machine 10A and the master machine 10B to operate as the master machine 10, the image processing apparatuses 100 that can operate as the master machine 10 coexist.

Here, in a case where the plurality of image processing apparatuses 100 are set to coexist as the master machine 10, the image processing apparatus 100 set as the slave machine 20 that can transmit the execution request for the processing of the service, and the image data to the plurality of master machines 10. In such a case, the slave machine 20 may set one of the plurality of image processing apparatuses 100 that can operate as the master machine 10, and may transmit the execution request for the processing of the service, and the image data to the selected image processing apparatus 100. In a case where the above-described example is used, the slave machine 20 makes the execution request for the processing of the service to the master machine 10. The master machine search unit 171 of the slave machine 20 checks the existence of the master machine 10A and the master machine 10B. By operating the slave machine 20, the user selects which master machine 10 to use. For example, in a case where the master machine 10A is selected by the slave machine 20, the master machine 10A selected from the slave machine 20 communicates with the slave machine 20 used by the user. However, the method of associating one master machine 10 with the corresponding slave machine 20 is not limited to this. For example, a system administrator may set to associate one master machine 10 with the corresponding slave machine 20 in advance by associating one master machine 10 with the corresponding slave machine 20 by using the IP address or the like.

In a case where the plurality of image processing apparatuses 100 that can operate exist, the system administrator need only determine whether to cause the plurality of image processing apparatuses 100 to coexist as the master machine 10 or to cause only a single image processing apparatus 100 to operate as the master machine 10.

In the present exemplary embodiment, in a case where the slave machine 20 receives the execution request for the processing of the service from the user, the slave machine 20 makes the execution request for the processing of the service via the master machine 10. Therefore, the external server 300 may not be able to discriminate from which slave machine 20 the execution request for the processing of the service is made. In such a case, the external server 300 cannot return a processing execution result or the like to the slave machine 20 that is a transmission source of the execution request for the processing. Therefore, in the present exemplary embodiment, an aspect can be adopted in which the master machine 10 adds information for identifying the slave machine 20 so that from which slave machine 20 the execution request for the processing of the service is made can be identified. For example, it is conceivable to add identification information of the slave machine 20 to an email header, an email subject, and the like. More specifically, an identifier may be added to the email subject, for example, “MFP-27F No. 123”. In addition, a notation such as “MFP27F123@example.com” may be added to the From or Sender field of the email header. In addition, “MFP Floor #123” may be described in the Comments field of the email header. In this way, by adding the identification information of the slave machine 20 to the master machine 10, the external server 300 can discriminate from which slave machine 20 the transmission is performed.

Although the exemplary embodiment of the present invention has been described above, the technical scope of the exemplary embodiment of the present invention is not limited to the above-described exemplary embodiment. In the above-described example, in a case where the slave machine 20 determines that the master machine 10 does not function, the slave machine 20 performs the authentication setting for the authorization server 200 by using the information, acquired from the master machine 10 in advance, for performing the authentication setting. On the other hand, an aspect can be adopted in which the slave machine 20 acquires the access token from the master machine 10 in advance. As a result, the slave machine 20 can immediately access the external server 300 without performing the authentication setting for the authorization server 200.

In addition, although the user ID and the password has been described as an example of the information for performing the authentication setting, an apparatus ID may be set for each image processing apparatus 100 and this apparatus ID may be used as the information for the authentication setting. In this case, the apparatus ID of the master machine 10 is used for the authentication to acquire the access token. In this way, the access token can be acquired to enable the access to the external server 300 only in a case of passing through the specific image processing apparatus 100 as the master machine 10.

Further, in the present exemplary embodiment, the slave machine 20 specifies the master machine 10 by searching for the peripheral master machine 10. On the other hand, the slave machine 20 corresponding to the specific master machine 10 may be set in advance. In addition, the master machine 10 corresponding to the specific slave machine 20 may be set. As a result, the slave machine 20 can immediately communicate with the master machine 10 without searching for the master machine 10. In addition, various modifications and alternative configurations are included in the present invention without departing from the technical idea of the present invention.

### SUPPLEMENTARY NOTE

(((1)))

A communication system comprising:

a plurality of image processing apparatuses for which a master machine and a slave machine are set,

wherein the image processing apparatus set as the slave machine has
a function of transmitting an execution request for processing of transmitting data to an external server, and image data of a transmission target to the image processing apparatus set as the master machine, and

the image processing apparatus set as the master machine has
a function of acquiring an access token for accessing the external server from an authorization server based on an authentication setting performed for the authorization server in advance, and accessing the external server by using the access token, and
a function of, in a case where the execution request and the image data are received from the image processing apparatus set as the slave machine, acquiring the access token for accessing the external server from the authorization server based on the authentication setting of the image processing apparatus set as the master machine, accessing the external server by using the access token, and transmitting the image data, in a form attached to an email, to the external server.

(((2)))

The communication system according to (((1))

wherein the image processing apparatus set as the slave machine
acquires information for performing the authentication setting for the authorization server from the image processing apparatus set as the master machine, and holds the acquired information, and
performs, in a case where a predetermined setting execution condition is satisfied, the authentication setting for the authorization server by using the held information, acquires the access token from the authorization server, accesses the external server, and transmits the image data, in a form attached to the email, to the external server.

(((3)))

The communication system according to (((1))) or (((2))),

wherein, in a case where the image processing apparatus set as the master machine is operating,

the image processing apparatus set as the slave machine
acquires information for performing the authentication setting from the image processing apparatus set as the master machine based on a predetermined acquisition condition.

(((4)))

The communication system according to (((2))) or (((3))),

wherein the setting execution condition includes at least any one of a fact that the image processing apparatus set as the master machine does not function as the master machine or a fact that connection to the image processing apparatus set as the master machine is not possible.

(((5)))

The communication system according to any one of (((1)) to

wherein, in a case where the transmission of the image data based on the execution request is not executable via the image processing apparatus set as the master machine,

the image processing apparatus set as the slave machine
performs an authentication setting for acquiring the access token from the authorization server for the authorization server, acquires the access token, accesses the external server, and transmits the image data, in a form attached to the email, to the external server.

(((6))

The communication system according to any one of ((1))) to (5)

wherein the image processing apparatus capable of acquiring the access token from the authorization server receives the execution request and the image data from the image processing apparatus set as another slave machine, and operates as the master machine.

(((7)))

The communication system according to any one of (((1))) to (6))),

wherein, in a case where there are a plurality of image processing apparatuses capable of operating as the master machine due to restoration of a function as the master machine of the image processing apparatus set as the master machine,

only one of the plurality of image processing apparatuses capable of operating as the master machine is set to operate as the master machine, and the other image processing apparatus is set to operate as the slave machine.

(((8)))

The communication system according to any one of (((1))) to (((7))),

wherein, in a case where there are a plurality of image processing apparatuses capable of operating as the master machine due to restoration of a function as the master machine of the image processing apparatus set as the master machine,

the image processing apparatus set as the slave machine selects one of the plurality of image processing apparatuses capable of operating as the master machine, and transmits the execution request and the image data to the selected image processing apparatus.

(((9)))

A communication control system that controls data communication in an image processing apparatus capable of acquiring an access token for accessing an external server from an authorization server, the communication control system comprising:

one or a plurality of processors configured to:
receive an execution request for processing of transmitting data to the external server, and image data of a transmission target from another image processing apparatus;
acquire an access token used for accessing the external server from an authorization server based on an authentication setting of the image processing apparatus in response to the execution request; and
access the external server in response to the execution request by using the acquired access token, and transmit the image data, in a form attached to an email, to the external server.

(((10)))

A program controlling a computer provided in an image processing apparatus capable of acquiring an access token for accessing an external server from an authorization server, the program causing the computer to implement:

a function of receiving an execution request for processing of transmitting data to the external server, and image data of a transmission target from another image processing apparatus;

a function of acquiring an access token used for accessing the external server from an authorization server based on an authentication setting of the image processing apparatus in response to the execution request; and

a function of accessing the external server in response to the execution request by using the acquired access token, and transmitting the image data, in a form attached to an email, to the external server.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A communication system comprising:
a plurality of image processing apparatuses for which a master machine and a slave machine are set,
wherein the image processing apparatus set as the slave machine has
a function of transmitting an execution request for processing of transmitting data to an external server, and image data of a transmission target to the image processing apparatus set as the master machine, and
the image processing apparatus set as the master machine has
a function of acquiring an access token for accessing the external server from an authorization server based on an authentication setting performed for the authorization server in advance, and accessing the external server by using the access token, and
a function of, in a case where the execution request and the image data are received from the image processing apparatus set as the slave machine, acquiring the access token for accessing the external server from the authorization server based on the authentication setting of the image processing apparatus set as the master machine, accessing the external server by using the access token, and transmitting the image data, in a form attached to an email, to the external server.

2. The communication system according to claim 1,
wherein the image processing apparatus set as the slave machine
acquires information for performing the authentication setting for the authorization server from the image processing apparatus set as the master machine, and holds the acquired information, and
performs, in a case where a predetermined setting execution condition is satisfied, the authentication setting for the authorization server by using the held information, acquires the access token from the authorization server, accesses the external server, and transmits the image data, in a form attached to the email, to the external server.

3. The communication system according to claim 2,
wherein, in a case where the image processing apparatus set as the master machine is operating,
the image processing apparatus set as the slave machine
acquires information for performing the authentication setting from the image processing apparatus set as the master machine based on a predetermined acquisition condition.

4. The communication system according to claim 2,
wherein the setting execution condition includes at least any one of a fact that the image processing apparatus set as the master machine does not function as the master machine or a fact that connection to the image processing apparatus set as the master machine is not possible.

5. The communication system according to claim 1,
wherein, in a case where the transmission of the image data based on the execution request is not executable via the image processing apparatus set as the master machine,
the image processing apparatus set as the slave machine
performs an authentication setting for acquiring the access token from the authorization server for the authorization server, acquires the access token, accesses the external server, and transmits the image data, in a form attached to the email, to the external server.

6. The communication system according to claim 5,
wherein the image processing apparatus capable of acquiring the access token from the authorization server receives the execution request and the image data from the image processing apparatus set as another slave machine, and operates as the master machine.

7. The communication system according to claim 5,
wherein, in a case where there are a plurality of image processing apparatuses capable of operating as the master machine due to restoration of a function as the master machine of the image processing apparatus set as the master machine,
only one of the plurality of image processing apparatuses capable of operating as the master machine is set to operate as the master machine, and the other image processing apparatus is set to operate as the slave machine.

8. The communication system according to claim 5,
wherein, in a case where there are a plurality of image processing apparatuses capable of operating as the master machine due to restoration of a function as the master machine of the image processing apparatus set as the master machine,
the image processing apparatus set as the slave machine selects one of the plurality of image processing apparatuses capable of operating as the master machine, and transmits the execution request and the image data to the selected image processing apparatus.

9. A communication control system that controls data communication in an image processing apparatus capable of acquiring an access token for accessing an external server from an authorization server, the communication control system comprising:
one or a plurality of processors configured to:
receive an execution request for processing of transmitting data to the external server, and image data of a transmission target from another image processing apparatus;
acquire an access token used for accessing the external server from an authorization server based on an authentication setting of the image processing apparatus in response to the execution request; and
access the external server in response to the execution request by using the acquired access token, and transmit the image data, in a form attached to an email, to the external server.

10. A non-transitory computer readable medium storing a program controlling a computer provided in an image processing apparatus capable of acquiring an access token for accessing an external server from an authorization server, the program causing the computer to implement:
a function of receiving an execution request for processing of transmitting data to the external server, and image data of a transmission target from another image processing apparatus;
a function of acquiring an access token used for accessing the external server from an authorization server based on an authentication setting of the image processing apparatus in response to the execution request; and
a function of accessing the external server in response to the execution request by using the acquired access token, and transmitting the image data, in a form attached to an email, to the external server.
